(19) United States
(12) Patent Application Publication
(10) Pub. No.: US 2010/0078383 A1
(43) Pub. Date: Apr. 1, 2010

(54) APPARATUS FOR LABORATORY DIALYSIS

(76) Inventor: Parikshit Bansal, Chandigarh (IN)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/529,125

(22) PCT Filed: Feb. 18, 2008
(86) PCT No.: PCT/IN08/00095

§ 371 Date: Aug. 28, 2009

(30) Foreign Application Priority Data
Mar. 1, 2007 (IN) 453/DEL/2007

(51) Int. Cl. B01D 61/24; B01D 61/28

(52) U.S. Cl. 210/644; 210/232

(57) ABSTRACT

The present invention describes a simple apparatus for the laboratory dialysis/desalting or purification of proteins. The same consists of a non-floating plate with means to attach a single or plurality of membrane based devices to carry out dialysis, such that only the membrane portion of the device comes into contact with the dialysate and no other portion or accessory, thus preventing any contamination due to the same.

### FIELD OF INVENTION

The field of invention pertains to methods of separation of chemical substances, including biological molecules e.g. proteins. More specifically, it pertains to an improved apparatus for carrying out laboratory dialysis.

### BACKGROUND TO THE INVENTION

Dialysis is defined as “A method for separating chemical substances by means of diffusion through a semi-permeable membrane.” (Encyclopedia Americana Vol. 9, p 57). The term was first used by a Scottish chemist, Thomas Graham, who in 1866 used a membrane to separate sugar from gum arabic. Dialysis is basically a purification method to separate large and small molecules, by diffusion through a semi-permeable membrane. A mixture of molecules is placed in a semipermeable membrane sac, which is then suspended in water or buffer. Smaller molecules in the mixture diffuse out through the pores of the membrane, while the large molecules remain inside the sac. Thus, after a period of time, separation occurs and a sample contaminated with small molecules becomes purified.

Dialysis is one of the most widely and commonly used procedures in life sciences research laboratories. Despite the availability of a number of commercially available devices, the search for an improved apparatus for carrying out laboratory dialysis remains a hot area of research, as the prior art devices suffer from one limitation or the other.

### PRIOR ART DEVICES

Dialysis tubing: One of the most commonly used methods of dialysis in the laboratory is by use of ‘dialysis tubing’ in which a tube of dialysis membrane is tied at the bottom with thread, filled with sample, tied again at the top with thread and floated in water or buffer to bring about dialysis. The method, though widely used suffers from several disadvantages:
1. Cumbersome: Tying of threads, opening them for sample removal etc. is a cumbersome process and very time consuming, especially if number of samples to be processed is large.
2. Reduced sample recovery: A considerable amount of sample is lost due to sticking to membrane, threads etc. Losses become significant, when volume of sample being processed is small.
3. Leakage: Owing to water inflow into the sac, especially when concentrated samples are being processed, sac swells up and chances of leakage are increased due to pressure on the sac.
4. Entanglement: To facilitate salt removal, the dialysis solution is subjected to stirring by using a magnetic bar, placed at the bottom of the container. In case of ‘dialysis sacs’ these sometimes get entangled or even accidentally ruptured owing to contact with the rapidly spinning magnetic bar.
5. Contamination by accessory : In case of the sac, apart from membrane an accessory i.e. thread is used. Thread gets fully immersed in the solution in which dialysis is being carried out and poses risk of contamination. Contamination can be due to dust or chemicals used in treatment of thread, which can leach out during dialysis.

Dialysis Cassettes: An improvement in method for dialysis has been described in U.S. Pat. No. 5,503,741, which provides a device for dialysis with hermetically sealed vacant chamber (Commercially available as “dialysis cassette”). The said device consists of a semi-permeable membrane sealed in a plastic frame. Sample is loaded and recovered with help of a syringe. The device offers an improvement over traditional methods of dialysis employing dialysis tubing. It is comparatively easier to use, as no tying of threads or clamping is involved and sample recovery is also higher than in case of dialysis tubing. However, it still suffered from following disadvantages:
1. Cumbersome sample loading and unloading: involving use of syringes and needles. In case of multiple samples, a number of syringes equal to number of samples, are required which makes the loading and recovery of sample, time consuming, tedious and expensive besides posing the risk of accidentally puncturing the membrane or causing injury to user. Also, the samples have to be recovered from each cassette one by one, which is time consuming.
2. Bulky accessories: The device is a floating device, necessitating the use of additional bulky ‘float’ accessories.
3. Contamination by accessory : Frame in which the membrane is fixed is the accessory. It gets fully immersed in the solution in which dialysis is being carried out and poses risk of contamination. Contamination can be due to chemicals or dyes leaching out from frame, during dialysis.

### Improved Dialysis Device

The problem of cumbersome sample loading and recovery as described above, was overcome, in an improved device for dialysis as described by Barisal and Bhatia (U.S. Pat. No. 6,368,509). The device, though offering considerable ease of use owing to a novel sample loading and collection method not involving use of syringes or needles, still suffered from certain limitations, associated with ‘floating devices’ for dialysis. Both the inventions for dialysis described in U.S. Pat. No. 5,503,741 and U.S. Pat. No. 6,368,509 involve use of floating devices., In general, floating devices are associated with certain problems which are described below:

### Disadvantages of Floating Devices Used for Dialysis

1. Sample contamination: Accessories e.g. hollow floats, support sheets etc. become dirty over a period of time. During dialysis, they come into contact with the solution against which sample is being dialysed, resulting in contamination of the solution, which can affect results.
2. Reduced space for samples: Being bulky, float accessories occupy considerable space in the vessel in which dialysis is being carried out, reducing space available for the dialysis devices.
3. Bulky external dimensions pose practical problems: Owing to bulky external dimensions, large-sized containers are required.
4. Device toppling : In case of device described in U.S. Pat. No. 6,368,509, a peculiar problem of device ‘toppling’ was encountered when low volumes of sample were being processed. This was due to the large volume of the sac as compared to weight of the membrane and also sample inside it, which resulted in low densities (density=mass/volume), causing the device to topple over. Owing to toppling of the device at lower volumes, the volume range over which the device could be used became restricted i.e. for higher volumes, the device could be used but for smaller volumes, a separate device with smaller dimensions was needed.

Problems Solved by the Present Invention
These problems have been overcome in the present invention, in a simple but novel manner, involving use of an apparatus for dialysis in which use of a specially designed, non-floating, dialysis support plate has been described for the first time. This simple but novel innovation, resulted not only in solving of existing problems associated with floating devices, but also resulted in several other technical advantages, not possible in floating devices of prior art, as follows:
1. Risk of sample contamination due to ‘dirty’ float accessory eliminated: The non-floating, dialysis support plate is placed over the rim of the beaker/container containing the dialysis solution. It does not come into contact with. the solution at all. Hence, any risk of contamination, due to a ‘dirty’ float accessory or due to leaching of chemicals from the accessory is altogether eliminated.
2. Compact outer dimensions, result in optimum use of space: The dialysis support plate, as proposed under the present invention, is non-floating. It has compact dimensions as compared to the floating accessories, which are bulky and occupy too much space. As a result of compact dimensions, optimum number of units can be processed at one go. Also, since the plate is non-floating, it does not have to be placed inside the container containing the dialysate solution, thus eliminating the need for specially designed large containers. As the dialysis support plate is placed over the rim of the container, any suitable glass beaker easily available in the lab, can be used for performing dialysis.
3. Problem of toppling over, of dialysis device eliminated: As the plate is of non-floating type, a dialysis unit once fixed into it, cannot topple.
4. Problem of separate devices for processing large and small volumes eliminated: e.g. for dialysis device as described in U.S. Pat. No. 6,368,509 separate devices are needed, as the device topples over when processing low volumes of samples for dialysis. However, in the present invention, irrespective of volume of sample inside the device, no toppling occurs as device is non-floating. Hence, a single device can be used for processing a wide range of sample volumes resulting in simplification of inventories and also convenience for laboratory users.
5. Time for recovery of dialysed samples drastically reduced: Unlike in case of floating devices; in which sample from each device has to be recovered one by one, in case of present invention all the samples get recovered simultaneously when the plate is lifted, as devices are attached to the plate, thus drastically removing the time for collection of the processed samples!

### Non-Obviousness of the Present Invention

At first glance; the use of a top, non-floating, non-contaminating support plate into which dialysis units can be fitted, appears to be simple and obvious. However, it is not so. None of the commercially available devices uses a non-floating support till date. Surprisingly, all the laboratory dialysis devices in prior art are floating type and the fact that accessories used for floating could be a cause for contamination, escaped attention.

Even in the earlier invention described in U.S. Pat. No. 6,368,509 in which the present inventor is a co-inventor, the dialysis device described is a floating one. Use of a non-floating support plate has not been described anywhere in prior art. In fact, the inventor faced considerable technical problems which ultimately led to the present invention consisting of an improved apparatus for dialysis employing a non-floating, non-contaminating support plate for membrane devices used for dialysis. The present invention was arrived at by trying a number of technical approaches to the problem of toppling of the device as described in. U.S. Pat. No. 6,368,509. The following technical approaches were used:
1. Reduction in height of the device: Height of the hollow float chamber was reduced, but did not prevent toppling of the device.
2. Increase in size of base of the device: Increase in size of the base was carried out by the inventor in successive stages, but failed to prevent toppling.
3. Increase in weight of the base of the device: To prevent the device from toppling, weight loading at the base was carried out using iron ball bearings. Even this failed to stabilize the device, which continued to topple.

Apart from these problems, it was also realized that stabilizing the device by making alterations in design with respect to height, base size, base weight etc. would lead to bulky design, besides increasing cost of the device.

It was then realized by the present inventor, that floating devices posed certain peculiar problems, which needed to be addressed.

It was also realized that use of floating accessories was leading to contamination of the solutions, as these accessories were being re-used while the dialysis units being disposable were discarded. Also, chemicals and dyes used in construction of the accessories could leach out and contaminate solutions.

It was after taking into consideration the repeated technical failures of stabilizing the floating dialysis device and also realizing the contamination being caused by ‘float accessories’ that the inventor realized the need for a ‘non-floating, non-contaminating’ dialysis unit support plate, which led to the present invention which has not been described in the prior art. To enable convenient and practical use of such a ‘non-floating dialysis support plate, a number of innovations were carried out in the construction of the dialysis unit support plate by the inventor with respect to choice of material and design.

### OBJECT OF THE INVENTION

It is an object of the invention to provide a simple apparatus for carrying .out laboratory dialysis in an easy, effective and efficient manner without the associated problems of existing devices.

### SUMMARY OF THE INVENTION

The present invention discloses a simple but novel apparatus for dialysis, employing a specially designed, non-floating, non-contaminating, dialysis unit support plate. The innovation in the present invention lies in three aspects.

1. Elimination of float accessories and resulting contamination of solutions: This has been made possible by, use of a specially designed rigid, flat plastic plate with holes, into which dialysis units can be fitted by push-fit. The plate is then placed over the rim of the container, which is filled with water or buffer, for carrying out dialysis. Since the plate remains outside the container and does not come into contact with the solution in which dialysis is being performed, there is no risk at all of any contamination occurring. This is in contrast to the floating accessories, which have to be placed in the dialyzing solutions and if they are not clean, contamination will occur.

2. Elimination of the problem of toppling of the dialysis devices during operation: Problem of toppling of the dialysis devices at low sample volumes at low volumes has been eliminated. Since dialysis devices are fitted into the plate during dialysis, they remain vertical and fully submerged in the solution. Problem of stoppage of dialysis or reduction in surface area of device due to toppling of the device is altogether eliminated.

3. Faster and convenient. recovery of the processed samples: Just lifting of the plate results in removal of samples from the dialysate solution, aiding in faster and convenient recovery of the processed samples.

4. Need for specially designed or large sized containers eliminated: Since the support plate is placed outside the container and rests on the rim of the open top of a container, any glass beaker available in the lab can be conveniently used. As mouth of glass beakers of standard capacity is almost the same internationally, size of the support plate is conveniently determined, so that it can be placed over the rim of beakers of widely varying volume. In case of present invention, the support plate designed can be conveniently placed over beakers ranging in size from 250 ml to 5000 ml!

### STATEMENT OF INVENTION

Accordingly, the present invention relates to an apparatus for laboratory dialysis of samples, comprising:

A non-floating dialysis unit support plate having means to ensure push-fitting of single or plurality of membrane fitted, dialysis devices into the plate, which can then be placed over rim of a container containing the dialysate solutions e.g. buffer or distilled water, so that only the dialysis membrane fitted portion of the device is in contact with the dialysate solution and not the plate.

Since the plate remains outside the container and does not come into contact with the solution in which dialysis is being performed, there is no risk at all of any contamination occurring. This is in contrast to the floating accessories, which have to be placed in the dialyzing solutions and if they are not clean, contamination will occur. Also, chemicals and dyes used in fabrication of the accessory can leach out during dialysis, leading to contamination.

### BRIEF DESCRIPTION OF THE DRAWINGS

FIG. 1 Non-floating dialysis unit support plate (1) having means (2) to enable attachment of plurality of membrane devices to the plate and also means (3) to enable convenient holding of the plate by human hands while units are being fitted.

FIG. 2 Membrane device (7) consisting of a hollow chamber (4) and a membrane sac (5) attached to the hollow chamber by means of a ring (6).

FIG. 3 Dialysis plate (1) loaded with membrane units (7) FIG. 4 Fully assembled apparatus consisting of dialysis plate (1), membrane units (7) loaded with sample (8) affixed to plate placed over a container (9) containing buffer, water or any other suitable solution (10) and a magnetic bar (11) to carry out stirring of the solution during dialysis.

FIG. 5 Operation of the apparatus
a. Loading sample (8) into hollow chamber (4) of the membrane device (7),
b. Fitting membrane sac (5) over the chamber (4)
c. Inverting device so that sample (8) drains into the membrane sac (5)
d. Fitting membrane devices (7) into the plate (1)
e. Placement of the plate over a beaker filled with water/buffer and containing magnetic stirrer
f. Removal of the plate after dialysis
g. Removal of the units from the plate
i. Sample recovery, by removal of membrane sac

### DETAILED DESCRIPTION OF THE INVENTION WITH REFERENCE TO THE DRAWINGS

The present invention describes a simple apparatus for carrying out dialysis of laboratory samples, in a convenient, easy and efficient manner. The apparatus of the present invention consists of the following:

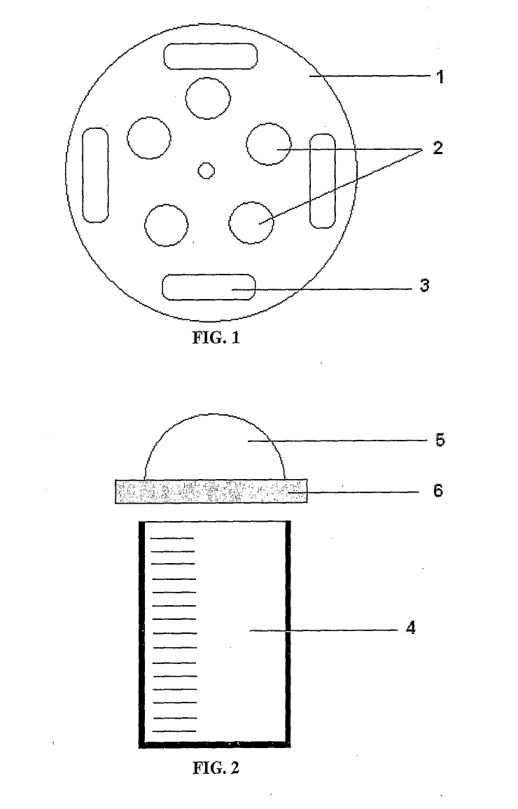

1. Dialysis Support plate (FIG. 1)

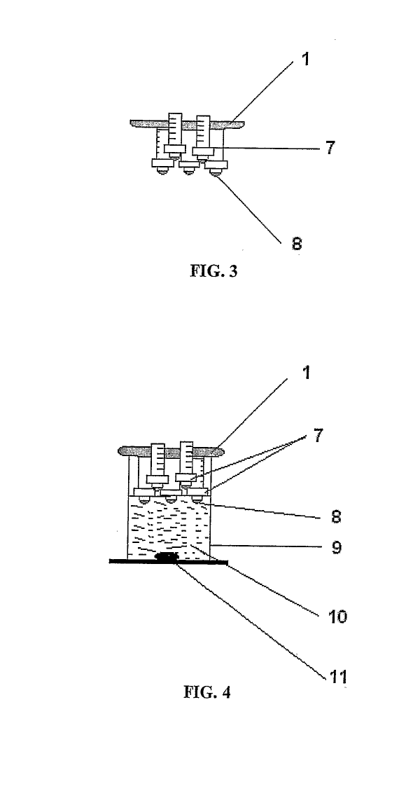

2. Membrane devices (FIG. 2)

3. Container filled, with buffer/water or any other appropriate solution for dialysis, as per requirements of experimental conditions of the researcher (FIG. 4)

The dialysis support plate has a number of innovative features, which result in its practical use in an easy and convenient manner, during dialysis. These are as follows: 1. Circular shape and lateral cuts: The plate (1) is circular and has got lateral cuts (3) along the border. The cuts offer distinct technical and commercial advantages as follows:
Enable convenient handling by human hands: The external diameter of a 5 liter beaker is approximately 7 inches. Hence, plate has to be designed with a diameter slightly more than 7 inches. The average diameter of a comfortably stretched human hand is about 5.5 to 6 inches. Since plate has to be held with one hand, while with other hand units are being fitted into it, there has to be a means to allow comfortable holding Of the plate with a single human hand. Accordingly, lateral cuts about 3 inches wide and 1 inch broad are provided along the periphery of the plate, so that the plate-can be grasped firmly and comfortably by a human hand.
Lateral cuts vs holes: Lateral cuts of the dimensions described above i.e. 1×3 inches (width×length) are practical, as thickness of human fingers varies from individual to individual. In case holes were provided along the periphery of the plate, individuals with thick fingers would not be able to hold the plate with one hand.
Commercial advantages: Providing lateral cuts in the plate reduces amount of material being used in the construction of the plate, thus making manufacturing more economical.

2. Use of Acrylonitrile Butadiene Styrene (ABS) as the material of construction: To ensure adequate gripping of the dialysis units so that they did not fall during dialysis a variety of plastic materials were evaluated by the inventor. Eventually ABS was found to be the most suitable owing to rigidity, aesthetics, strength, economical reasons and the fact that it can be injection molded and mass production is possible. A plate of 2 mm thickness was found to be quite adequate in providing necessary mechanical support to multiple dialysis units, without any bending. To provide additional strength to the plate, ribs were provided along the openings where the dialysis units were to be fitted.

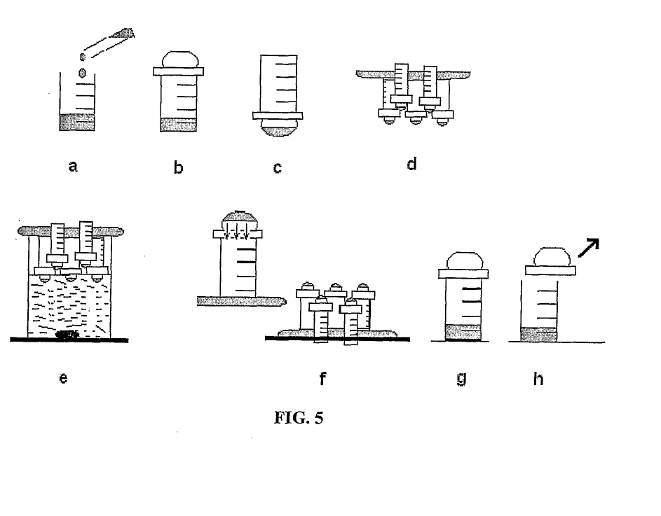

3. Openings in the plate for push-fitting of the dialysis devices: The plate has got specially designed openings (2) corresponding to the external shape of any suitable dialysis device which has to be fitted into the plate. e.g. in device described in U.S. Pat. No. 6,368,509, the shape of that portion of the dialysis device which has to be fitted into the place, is cylindrical. Accordingly, circular holes are provided in the plate, into which the device can be push-fitted, so that only the membrane portion of the device comes into contact with the solution e.g. buffer or water, in which dialysis is being carried out. (FIG. 3 and FIG. 4)

In an embodiment of the present invention, the flat support plate can be square, rectangular or even polygonal. The opening in the plate can be of any shape, corresponding to the external shape of the device which is being push-fitted into these openings. Naturally, embodiments of the principle of the invention other than those described above can be carried out without departing from the scope of the invention.

In yet another embodiment, the dimensions of the hollow chamber of the membrane devices can correspond to external dimensions of off-the shelf available centrifuge tubes, so that the device after use can directly be centrifuged to facilitate maximum sample recovery. In such an embodiment, holes in the plate can have appropriate dimensions corresponding to dimensions of the hollow chamber of the membrane devices being fitted into the plate.

Apart from dialysis, the convenient format of the device permits its use for pharmaceutical related diffusion studies or culture studies, in which diffusion of small molecules across a membrane barrier or other aspects can be easily studied, since it is only the membrane which comes into contact with the liquid and no other part e.g. accessory, which can be a source of contamination or interfere in experiments. Once the basic design and functioning of the apparatus is clear, its use for other applications besides dialysis is quite easy for a person skilled in the art

Example 1

### Dialysis of a Sample in the Laboratory by Use of the Present Invention is Described Below

### Assembly of Apparatus

The sample to be dialyzed (8) is loaded into the hollow chamber (4), of the membrane device, simply by pouring (FIG. 5a).
A ring, fitted with membrane sac is attached to open end (FIG. 5b).
Device is inverted so that sample flows into the membrane sac (FIG. 5c)
Holding the dialysis support plate with one hand, the dialysis device loaded with the sample is push-fitted into the support plate. Several membrane units can be fitted into one plate, as shown (FIG. 5 d).

### Operation

The support plate fitted with the dialysis units, is placed over the rim of a container filled with buffer or distilled water (10), so that the membrane fitted portion is submerged in the liquid and salt removal can occur across the membrane (FIG. 5e).

### Recovery of the Processed Sample

After the end of dialysis, the support plate 1 is removed and inverted (FIG. 5f).
As a result, the dialysed sample drains from the membrane sac (5) into the hollow chamber (1). (FIG. 5 g) from where it can be removed conveniently by detaching the membrane sac (FIG. 5 h).
In case multiple dialysis units are fitted into the support plate, sample collection in all the units will ,occur simultaneously when the devices are inverted, thus making sample collection easy, fast and efficient.
Processed sample can be directly stored in chamber 1 only or removed and processed further as per experimental requirements.

Naturally, the embodiments of the principle of the invention other than those described by way of example may be carried out without departing from the scope of this invention. Such variations are not to be regarded as a departure from the spirit and scope of the invention, and all such modifications as would be obvious to one skilled in the art are intended to be included within the scope of this invention.

1. An apparatus for dialysis of laboratory samples comprising in combination:
a) a non-floating support plate configured for
attachment of single or plurality of membrane devices to the plate, to be placed over rim of a container containing the dialysate solutions e.g. buffer or distilled water for dialysis to occur;
comfortable holding by one human hand so that membrane units can be fixed into the plate by other hand
b) a membrane device comprising
a hollow chamber closed at one end and open at the other;
a preformed membrane sac which can be attached to the open end of the hollow chamber in a detachable manner so that interior of the membrane sac and hollow chamber are in flow-communication with each other; the preformed membrane sac being permanently attached to a supporting ring having a central aperture such that the membrane sac is permanently disposed above the central aperture
wherein all non-membrane parts of the apparatus remain completely outside the dialysate solution and only membrane part of the apparatus comprising of the membrane sac comes into contact with the dialysate solution.

2. The apparatus as claimed in claim 1 wherein the non-floating support plate defines a hole into which the membrane device is push-fitted.

3. The apparatus as claimed in claim 1 wherein the non-floating support plate defines a plurality of holes into which the membrane devices are push-fitted.

4. The non-floating support plate as claimed in claim 3, wherein the plurality of holes in the plate are suitably labelled by alphabets or numbers.

5. The non-floating support plate as claimed in claim 1, wherein the plate is made up of suitable rigid material such as plastic selected from the group comprising nylon, polypropylene, Acrylonitrile Butadiene Styrene (ABS) or the like.

6. The apparatus as claimed in claim 1 further including lateral cuts along the periphery of the plate, to facilitate comfortable holding of the non-floating support plate.

7. The apparatus as claimed in claim 1 further including lateral cuts along the periphery of the plate, having dimensions of about 3 inches long and about 1 inch broad, to facilitate comfortable holding of the non-floating support plate.

8. A method of dialysis according to the apparatus as claimed in claim 1 comprising the steps of sample loading, dialysis and sample recovery as follows:
Providing the apparatus as claimed in claim 1;
Placing the sample to be purified in the hollow chamber of the membrane device, via the opening at the top;
Attaching membrane sac to the hollow chamber using the ring supporting the membrane sac;
Inverting the membrane device so that the sample flows from the hollow chamber into the membrane sac;
Attaching singly or plurality of membrane devices to the non-floating support plate by push fit
placing the non-floating support plate with membrane devices attached, over the rim of a container filled with buffer or distilled water, so that only the membrane portion of the device comes into contact with the buffer or water and dialysis occurs
recovery of the processed samples after dialysis further comprising the steps of:
removing the apparatus from the container after dialysis by lifting the support plate and inverting the plate so that the processed sample or samples in case of multiplicity of devices being attached to plate, drain from the membrane sac into the hollow chamber;
detaching the membrane sac from the hollow chamber for recovering the processed sample simply by pouring out.

9. An apparatus for the dialysis/desalting or purification of samples and method thereof as herein described and illustrated in the specification with reference to the accompanying drawings.
